(19) United States
(12) Patent Application Publication
(10) Pub. No.: US 2007/0075284 A1
(43) Pub. Date: Apr. 5, 2007

(54) Diaphragm valve

(75) Inventors: Akinori Masamura, Komaki-shi (JP); Norikazu Tsuji, Komaki-shi (JP)

Correspondence Address: OLIFF & BERRIDGE, PLC, P.O. BOX 19928, ALEXANDRIA, VA, 22320, US

(73) Assignee: CKD Corporation, Komaki-shi (JP)

(21) Appl. No.: 10/576,258

(22) PCT Filed: Nov. 2, 2004
(86) PCT No.: PCT/JP04/16246

§ 371 Date: Apr. 18, 2006

(30) Foreign Application Priority Data
Nov. 7, 2003 (JP) 2003-378210
Apr. 23, 2004 (JP) 2004-127985

(51) Int. Cl. F16K 31/122; F16K 31/00

(52) U.S. Cl. 251/63.5; 251/331

(57) ABSTRACT

To provide a diaphragm valve 1 in which a diaphragm valve element 20 airtightly closes open ends on an upper surface of a body 10 to provide a valve-closed state when the diaphragm valve element 20 is pressed against a valve seat 13 by urging force of an urging member 33, and to provide a valve-open state when the diaphragm valve element 20 is separated from the valve seat 13. The diaphragm valve element 20 comprises a main body 21 in contact with the valve seat 13, a diaphragm part 22 extending outwards from the main body 21, and a fixed part 23 formed at a peripheral edge of the diaphragm part 22. A root 25 of the diaphragm part 22 formed in the main body 21 is positioned inside a diameter of the valve seat 13 and lower than the peripheral edge of the diaphragm part 22 which extends in a curve in a valve-closed state.

### TECHNICAL FIELD

The present invention relates to a diaphragm valve used in a semiconductor manufacturing device to control a chemical liquid and more particularly to a diaphragm valve capable of maintaining a valve-closed state with a low load and preventing the occurrence of water hammer.

### BACKGROUND ART

In a chemical liquid valve used in a semiconductor manufacturing device to control a chemical liquid, a diaphragm valve shown in FIG. 4 for example is conventionally used. This diaphragm valve 100 has a first flow passage 111 and a second flow passage 112 both formed in a body 110. These passages 111 and 112 have ports opening into side surfaces of the body 110 and open into an upper surface of the body 110. The second flow passage 112 is in communication with a valve hole 114 formed inside a valve seat 113, whereas the first flow passage 111 is in communication with the outside of the valve seat 113. On the upper surface of the body 110 into which one ends of the first and second flow passages 111 and 112 open, a diaphragm valve element 115 is arranged. This diaphragm valve element 115 is held, at its peripheral portion, between the body 110 and a cylinder 120, providing an airtight space around the open ends of the first and second flow passages 111 and 112.

The diaphragm valve element 115 includes a main body 117 which will be brought into/out of contact with the valve seat 113 and a diaphragm part 118 radially extending from the periphery of the main body 117. The diaphragm part 118 is circumferentially formed with an annular fixed part 119 which is held tightly between the body 110 and the cylinder 120. In this cylinder 120, a piston rod 121 is mounted to be slidable in a vertical, or axial, direction. A lower end of the piston rod 121 is coupled to the main body 117 of the diaphragm valve element 115. Attached on the cylinder 120 is a cover 122 in which a spring 123 is mounted to urge the piston rod 121 downward. The cylinder 120 is formed with an operation port 125 through which air is supplied into the cylinder 120 to apply pressure to the piston rod 121 against the urging force of the spring 123.

In the above diaphragm valve 100, normally, the piston rod 121 is urged downward by the spring 123, thereby pressing the main body 117 of the diaphragm valve element 115 against the valve seat 113, providing a valve-closed state.

When compressed air is supplied into the cylinder 120 through the operation port 25 of the body 110, the piston rod 121 is pressurized from below with the compressed air and allowed to slide upward against the urging force of the spring 123. Accordingly, the main body 117 is simultaneously moved up, separating from the valve seat 113 to allow communication between the first flow passage 111 and the second flow passage 112, providing a valve-open state.

When the supplied compressed air is discharged from the cylinder 120 through the operation port 125, the piston rod 121 is allowed to slide downward by the urging force of the spring 123 to a position for the valve-closed state shown in FIG. 4.

Patent Document 1: Japanese unexamined patent publication No. 2003-247650 (pages 2-3, FIG. 8)

### DISCLOSURE OF THE INVENTION PROBLEM TO BE SOLVED BY THE INVENTION

The conventional diaphragm valve 100, as described above, maintains the valve-closed state while the main body 117 is pressed against the valve seat 113 only with the urging force of the spring 123. However, the load of the spring 123 to maintain the valve-closed state has been heavy. As a result of this, the body 110 including the valve seat 113 and the diaphragm valve element 115, which are made of fluorine resin, are pressed by the excessively heavy load. This would cause a deformation in a contact portion between the valve seat 113 and the diaphragm valve element 115, resulting in a shortening of a useful life of the diaphragm valve 100. When the contact portion, or a sealing part is deformed, the valve seat 113 and the diaphragm valve element 115 can no more make contact with each other in an airtight state, which causes a leak of the liquid. Accordingly, the diaphragm valve 100 is demanded to have a configuration that the urging force of the spring 123 is controlled, and the load to bring the diaphragm valve element 125 into contact with the valve seat 113 is reduced.

With respect to an occurrence of the water hammer which has been a problem with a liquid control valve, the conventional diaphragm valve 100 will be further discussed.

Firstly, the water hammer will be explained.

When the liquid control valve is closed by a sudden piston stroke, the liquid in the second flow passage is likely to go on flowing out because of an inertial force thereof even after the liquid control valve is closed. Therefore, the liquid in the second flow passage receives the negative pressure, so that a back flow of the liquid pushes up and vibrates the diaphragm valve element, generating an impulsive sound. This phenomenon is called the water hammer. The water hammer has a risk of causing a vibration to piping and eventually damages to a pilot valve itself and the piping parts around the valve.

Now that the conventional diaphragm valve 100 will be discussed.

The liquid supplied to the second flow passage 112 flows into the first flow passage 111 after hitting against the diaphragm valve element 115 as shown in FIG. 8. Therefore, the main body 117 and the diaphragm part 118 receive pressure of the liquid supplied to the second flow passage 112 when the piston rod 121 slides downward by the urging force of the spring 123. As the piston rod 121 slides downward, a space between the diaphragm valve element 115 and the valve seat 113 becomes smaller as shown in FIG. 9. The liquid from the second flow passage 112 hits more strongly against the main body 117, but less strongly against the diaphragm part 118. Therefore, the liquid pressure applied to the main body 117 is increased, whereas the liquid pressure applied to the diaphragm part 118 is decreased. However, a pressure-applied area of the diaphragm part 118 is larger than that of the main body 117. Accordingly, the urging force applied to the entire diaphragm valve element 115 is significantly decreased as the liquid pressure applied to the diaphragm part 118 is decreased, so that the piston rod 121 coupled to the diaphragm valve element 115 is likely to slide downward suddenly by the urging force of the spring 123. This tendency becomes more remarkable as the piston rod 121 slides closer to the valve-closed position. As shown in FIG. 10, the diaphragm valve element 115 is suddenly brought into contact with the valve seat 113 to close the diaphragm valve 100, but the liquid in the first flow passage 111 goes on flowing out by the inertial force thereof even after the diaphragm valve 100 is closed.

As a result, the negative pressure is applied to the liquid in the first flow passage 111 side, so that the liquid flows back and pushes up the diaphragm valve element 115, which causes the water hammer. The water hammer has a risk of causing the vibration to the piping and eventually damages to the pilot valve itself and the piping parts around the valve.

Even if the supplying amount of the compressed air through the operation port 125 is reduced by use of an air adjustment mechanism (not shown), the change of the liquid pressure has larger influence on a closing operation of the diaphragm valve than the change of the air pressure to a pressure chamber.

### MEANS FOR SOLVING PROBLEM

The present invention has an object to overcome the above problems and to provide a diaphragm valve for bringing a diaphragm valve element into contact with a valve seat with a low load, and preventing the occurrence of water hammer.

The diaphragm valve of the present invention in which a diaphragm valve element airtightly closes open ends of a first flow passage and a second flow passage on an upper surface of a body, the diaphragm valve which is closed when the diaphragm valve element is pressed against a valve seat by urging force of an urging member, and is opened when the diaphragm valve element is separated from the valve seat by an actuator, is characterized in that the diaphragm valve element comprises a main body in contact with the valve seat, a diaphragm part extending outwards from the main body, and a fixed part formed at a peripheral edge of the diaphragm part, and a root of the diaphragm part formed in the main body is positioned inside a diameter of the valve seat and lower than the peripheral edge of the diaphragm part which extends in a curve in a valve-closed state.

Preferably, the diaphragm valve of the present invention is further characterized in that the diaphragm valve element in which the diaphragm part having a thin wall and the fixed part having a thick wall are formed so that respective upper surfaces are flush with each other, and the fixed part is held between an a lower fixing face and an upper fixing face which extends to the diaphragm part.

Preferably, the diaphragm valve of the present invention is further characterized in that a guide face having a slope contiguous from the upper fixing face above the diaphragm part so that the diaphragm part comes into contact with the guide face when the diaphragm valve element is separated from the valve seat.

Preferably, the diaphragm valve of the present invention is further characterized in that a fluid-pressure-receiving area of the valve body part is as large as or larger than a fluid-pressure-applied area of the diaphragm part.

### EFFECT OF THE INVENTION

The diaphragm valve of the present invention having the above structure is normally closed by the urging force of the urging member. Therefore, the flow of the liquid from the first flow passage is stopped, and the liquid is never supplied into the second flow passage being as a second passage. In this state, the pressure of liquid in the first flow passage and the back pressure of liquid in the second flow passage are exerted upward on the diaphragm valve to be opened. The urging force of the urging member is exerted downward to press the diaphragm valve. When the diaphragm valve element is pressed upward by the actuator against the urging force of the urging member, the diaphragm valve element is separated from the valve seat, providing the valve-open state, and then the liquid flows into the second flow passage from the first flow passage.

In the diaphragm valve element in the valve-opened state, the main body is separated from the valve seat and the diaphragm part becomes warped, as the main body moves up. In that time, the diaphragm valve element from the fixed part to the diaphragm part is supported by the upper fixing face. The diaphragm part is supported along the guide face.

The diaphragm valve element of the present invention comprises a main body in contact with the valve seat, a diaphragm part extending outwards from the main body, and a fixed part formed at a peripheral edge of the diaphragm part, and a root of the diaphragm part in the main body is positioned inside a diameter of the valve seat and lower than the fixed part formed at the peripheral edge of the diaphragm part which extends in a curve. Accordingly, the distance between the main body and the fixed part become shorter, so that an outer diameter of the diaphragm valve element applied with the liquid pressure can be smaller. This can reduce an area of the diaphragm valve element which receives the pressure of liquid acting to press up the diaphragm valve element. The load of the urging member to bring the diaphragm valve element into contact with the valve seat for the valve-closed state can be also decreased. Accordingly, the piston rod is allowed to slowly slide downward even just before the valve-closed state when the diaphragm valve is returned to the valve-closing position. This makes it possible to prevent the occurrence of the water hammer.

The present invention can achieve the above effects by the configuration that the root of the diaphragm part in the main body is positioned inside the diameter of the valve seat and the diaphragm valve element has a small pressure-applied area. Additionally, the fixed part at the peripheral edge of the diaphragm part which extends in a curve is held at the position higher than the root of the main body, so that the diaphragm part can be unforcedly warped by the stroke of the main body in the valve opening and closing operation.

Furthermore, in the diaphragm valve, a boundary portion between the fixed part and the diaphragm part in which the cross-sectional areas largely change is supported by the upper fixing face, so that the deformation in the boundary portion is controlled when the diaphragm part is warped in the valve-closing/opening operation to reduce the concentration of the force thereto. Further, the diaphragm part is supported by and along the guide face, which can also reduce the concentration of the force to the boundary portion of the diaphragm part and the fixed part of the diaphragm valve element when the diaphragm part is warped.

### BRIEF DESCRIPTION OF DRAWINGS

FIG. 1 is a sectional view of a diaphragm valve of the embodiment in a valve-closed state;

FIG. 2 is a sectional view of the diaphragm valve of the embodiment in a valve-open state;

FIG. 3 is a partial enlarged sectional view of a diaphragm valve element;

FIG. 4 is a sectional view of a conventional diaphragm valve;

FIG. 5 is a sectional view showing a distribution of liquid pressure applied to the diaphragm valve element in the valve-open state of the diaphragm valve of the present invention;

FIG. 6 is a sectional view showing the distribution of the liquid pressure applied to the diaphragm valve element during a transitional period from the valve-open state to the valve-closed state of the diaphragm valve of the present invention;

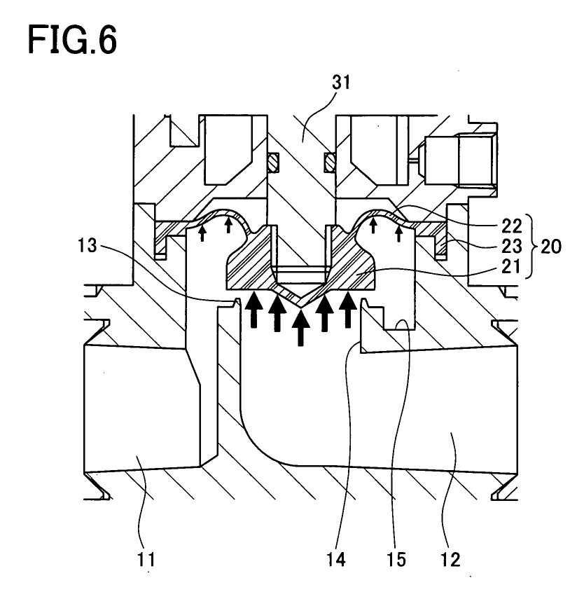

FIG. 7 is a sectional view showing the distribution of the liquid pressure applied to the diaphragm valve element in the valve-closed state of the diaphragm valve of the present invention;

FIG. 8 is a sectional view showing the distribution of the liquid pressure applied to the diaphragm valve element in the valve-open state of the conventional diaphragm valve;

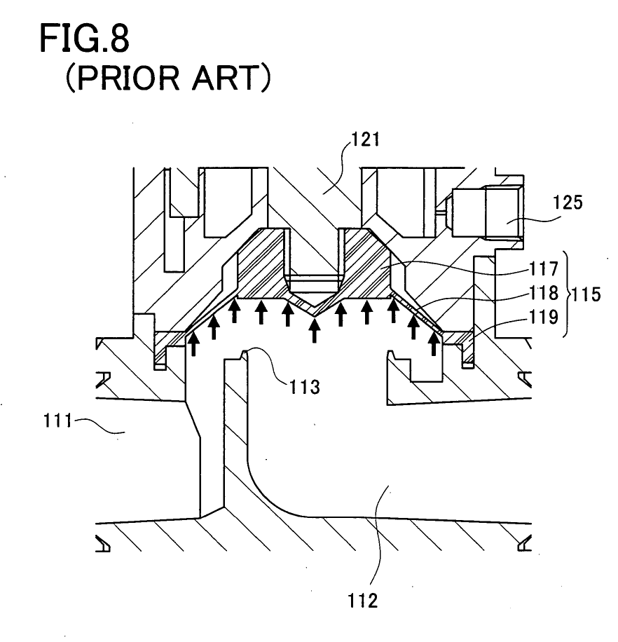

FIG. 9 is a sectional view showing the distribution of the liquid pressure applied to the diaphragm valve element during a transitional period from the valve-open state to the valve-closed state of the conventional diaphragm valve; and

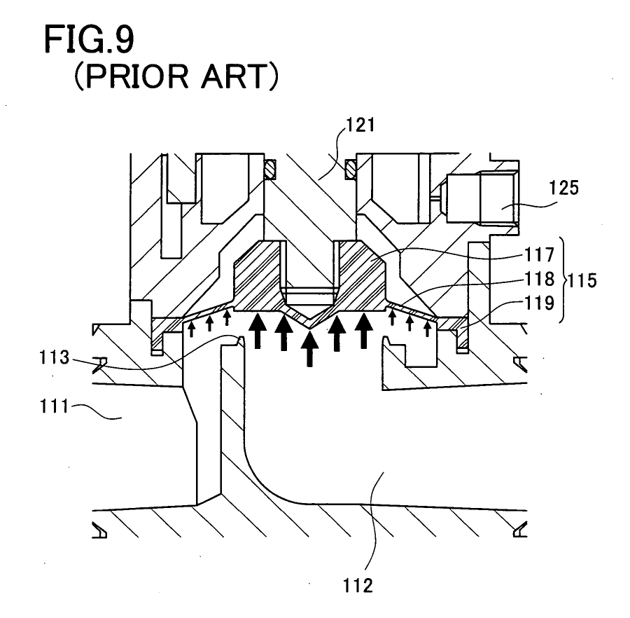

FIG. 10 is a sectional view showing the distribution of the liquid pressure applied to the diaphragm valve element in the valve-closed state of the diaphragm valve of the conventional diaphragm valve.

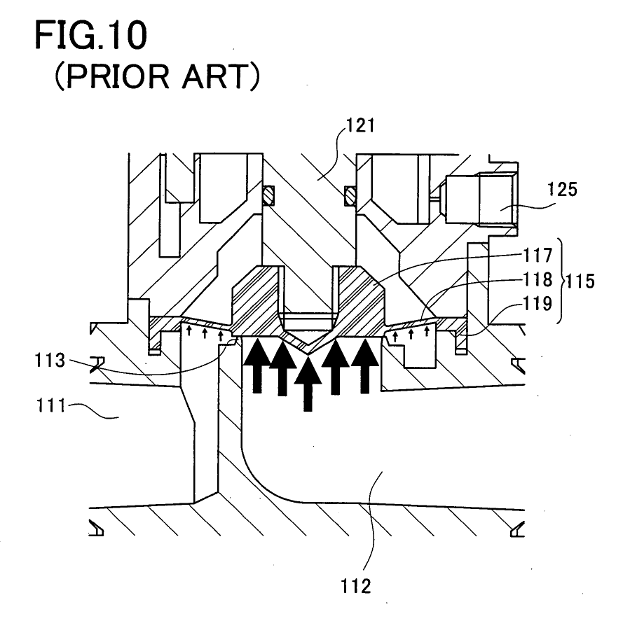

### EXPLANATION OF REFERENCE NUMERAL

| | |
|---|---|
| 1 | Diaphragm Valve |
| 10 | Body |
| 13 | Valve Seat |
| 20 | Diaphragm Valve Element |
| 21 | Main Body |
| 22 | Diaphragm Part |
| 23 | Fixed Part |
| 30 | Cylinder |
| 31 | Piston Rod |
| 33 | Spring |
| 35 | Operation Port |

### BEST MODE FOR CARRYING OUT THE INVENTION

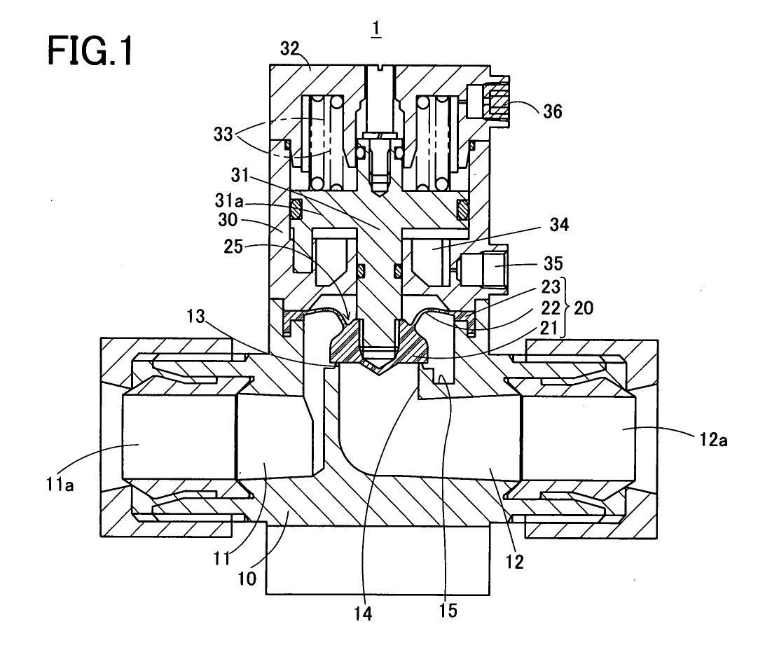

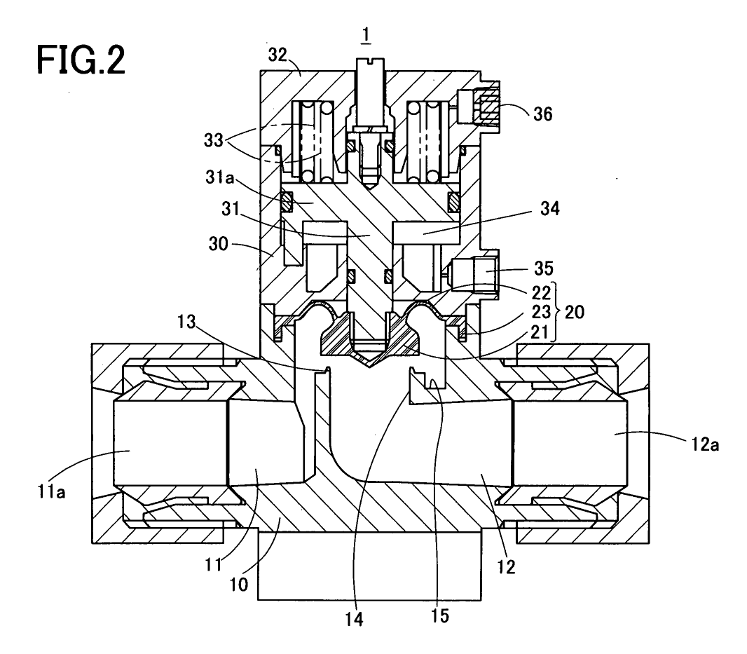

A detailed description of a preferred embodiment of the present invention will now be given referring to the accompanying drawings. FIG. 1 is a sectional view of a diaphragm valve of the embodiment in a valve-closed state. FIG. 2 is a sectional view of the diaphragm valve of the embodiment in a valve-open state. A diaphragm valve 1 shown in FIGS. 1 and 2 is a chemical-liquid valve installed in a semiconductor manufacturing device to control a chemical liquid.

The diaphragm valve 1 has a first flow passage 11 and a second flow passage 12 both formed in a body 10. The first flow passage 11 and the second flow passage 12 have a port 11a and a port 12a respectively in side surfaces of the body 10. A valve seat 13 is provided in a center of an upper surface of the body 10. The second flow passage 12 is in communication with a valve hole 14 formed inside the valve seat 13, whereas the first flow passage 11 is in communication with a circular groove 15 formed around the valve seat 13. Both of the first and the second flow passages 11 and 12 are in communication with an upper opening of the body 10, and the opening is covered with the diaphragm valve element 20. The diaphragm valve element 20, particularly, is held at its peripheral portion to provide an airtight space allowing communication between the first and the second flow passages 11 and 12.

The diaphragm valve element 20 includes a main body 21 which will be brought into/out of contact with the valve seat 13, a diaphragm part 22 radially extending from the periphery of the main body 21, and a fixed part 23 which is circumferentially formed at an outer peripheral edge of the diaphragm part 22. FIG. 1 shows the diaphragm valve 1 in the valve-closed state which is nearly a normal state wherein the fixed part 23 is held between the body 10 and a cylinder 30, the diaphragm part is curved as shown in FIG. 1, and the main body 21 is in contact with the valve seat 13. The diaphragm valve element 20 is made of a fluorine resin as well as the body 10. Both of the main body 21 and the valve seat 13 which are in/out of contact with each other are also made of the fluorine resin.

In the cylinder 30, a piston rod 31 is mounted to be slidable in a vertical, or axial, direction. A lower end of the piston rod 31 is coupled to the main body 21 of the diaphragm valve element 20. In the diaphragm valve 1, the main body 21 of the diaphragm valve element 20 is brought into/out of contact with the valve seat 13 as the piston rod 31 slides up and down.

A cover 32 is attached on an upper opening of the cylinder 30. In a space in the cylinder 30 closed by the cover 32, a spring 33 is mounted to urge a piston 31a of the piston rod 31 downward. The diaphragm valve 1 is a normal-closed-type valve in which the spring 33 always urges the piston rod 31 downward, and the main body 21 is in contact with the valve seat 13 as shown in FIG. 1. A pressure chamber 34 is provided under the piston 31a of the piston rod 31. To supply compressed air to the pressure chamber 34, an operation port 35 is formed in the cylinder 30. Further, the cylinder 30 has a air port 36 in communication with the space over the piston 31a in which the spring 33 is mounted.

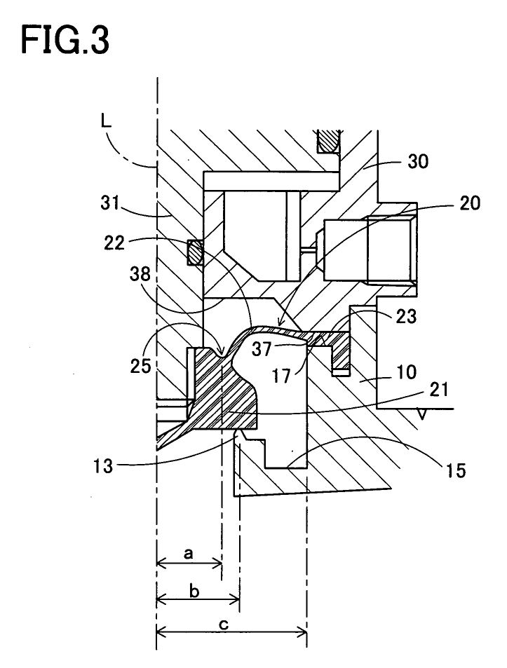

The diaphragm valve 1 of the above structure is characterized in the diaphragm valve element 20 including the main body 21, the diaphragm part 22 and the fixed part 23. FIG. 3 is a partial enlarged sectional view of the diaphragm valve element 20.

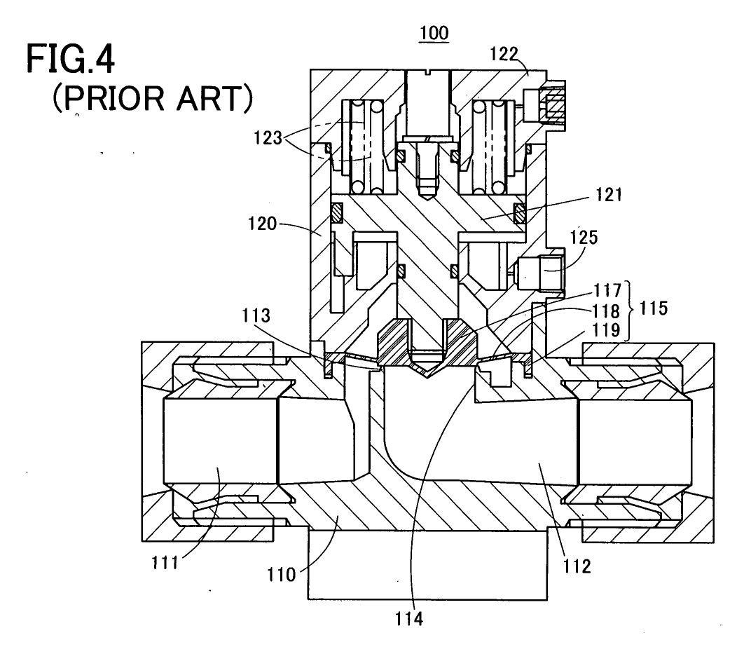

The diaphragm part 22 radially extending from the main body 21 is formed so that a root 25 thereof on the main body 21 side can be positioned close to a center line L of the diaphragm valve element 20 (a central axis of the piston rod 31). More specifically, a distance “a” from the center line L to the root 25 is shorter than a distance “b” from the center line L to the valve seat 13, and the root 25 is positioned closer to the center line L than the valve seat 13 is. This feature will be compared with the conventional example in FIG. 4. In the conventional diaphragm valve element 115, a root of the diaphragm part 118 is positioned on the side of the main body 117 which is the closest position to a fixing position of the fixed part 119, whereas the root 25 in the present embodiment is positioned farthest from the fixed part 23.

The diaphragm part 22 extends upward from the root 25 provided uprightly on an inclined surface of the main body 21, and is curved midway to extend sideways in cross section. Therefore, the fixed part 23 around the outer peripheral edge of the diaphragm part 22 is positioned higher than the root 25 in the valve-closed state as shown in FIG. 1, and held in sandwiched relation between the body 10 and the cylinder 30. A comparison in this respect between the diaphragm valve 20 of the embodiment and the conventional diaphragm valve 115, referring to each size of only the diaphragm parts 22 and 118, indicates that the lengths of the diaphragm parts 22 and 118 are not so different. However, a diameter of the fixed part 23 of this embodiment is smaller by its curve than that of the fixed part 119 of the prior art. Accordingly, the distance of the diaphragm part 22 to the fixed part 23 is shorter by its curve. In the body 10, the distance “c” to the outer peripheral edge of the groove 15 communicated with the first flow passage 11 is set to be smaller than the conventional one.

Next, the fixed part 23 of the diaphragm valve element 20 in this embodiment will be explained. The fixed part 23 of the diaphragm valve element 20 is held between the body 10 and the cylinder 30. A fixing face 17 of the body 10 on the lower side is in contact with only a thin part of the fixed part 23. On the other hand, the fixing face 37 of the cylinder 30 on the upper side extends in contact with part of the diaphragm part 22 as well as the fixed part 23. A boundary portion between the diaphragm part 22 and the fixed part 23 in which a cross-sectional areas largely change is supported along a direction to which the diaphragm part 22 is warped. Furthermore, the cylinder 30 is formed with a guide 38 recessed upward and inward from the fixing face 37. The guide 38 is slightly sloped from the fixing face 37, so that the diaphragm part 22 is supported along the warping direction in the valve-open state as shown in FIG. 2.

Next, the workings of the diaphragm valve 1 of the above structure will be explained. In the diaphragm valve 1, the piston rod 31 is normally urged downward by the spring 33. The main body 21 of the diaphragm valve element 20 which is secured to the lower end of the piston rod 31 is pressed against the valve seat 13 as shown in FIG. 1. In this diaphragm valve 1 in the valve-closed state, the flow is stopped by the diaphragm valve element 20. The liquid supplied into the first flow passage 11 never flows to the second flow passage 12, and the liquid having flowed into the second flow passage 12 never flows back to the first flow passage 11.

When the compressed air is supplied through the operation port 35 of the body 10, the piston 31a is pressed from below, and the piston rod 31 slides upward against the urging force of the spring 33. Therefore, the main body 21 secured to the piston rod 31 is simultaneously moved up separating from the valve seat 13 as shown in FIG. 2. This allows communication between the first flow passage 111 and the second flow passage 112, providing a valve-open state. The liquid when supplied to the first flow passage 11 flows into the second flow passage 12 through the groove 15 and the valve hole 14. The liquid when supplied to the second flow passage 12 flows into the first flow passage 11 through the valve hole 14 and the groove 15.

The diaphragm valve element 20 is allowed to slide, when the supplied compressed air is discharged from the pressure chamber 34 through the operation port 35, the piston rod 31 is allowed to slide downward by the urging force of the spring 33 to a position for the valve-closed state shown in FIG. 1, stopping the flow of the liquid.

In the diaphragm valve 1 in the valve-closed state as shown in FIG. 1, the flow pressure is applied to the diaphragm part 22 of the diaphragm valve element 20 in a valve-opening direction as the liquid is supplied to the first flow passage 11. Also, the second flow passage 12 as a second passage is filled with the liquid stopped flowing, so that the back pressure is exerted on the diaphragm part 22 of the diaphragm valve element 20 in the valve-opening direction.

In the diaphragm valve 1 of this embodiment, however, the root 25 of the diaphragm part 22 is positioned at the distance “a” from the center line L, and closer to the center line L than the valve seat 13 positioned at the distance “b” from the center line L is. Therefore, the diaphragm part 22 can have a reduced distance “c” from the center line L to the groove 15 while maintaining the diameter required for a stroke of valve-opening/closing operation. Accordingly, in the valve-closed state, the smaller area of the diaphragm part 22 receives the liquid pressure from the liquid filled in the groove 15 pressing the diaphragm valve element 20 upward in the valve-opening direction. As a result, the upward pressure exerted on the diaphragm part 22 can be decreased, so that the urging force of the spring 33 to close the diaphragm valve 1 can be reduced.

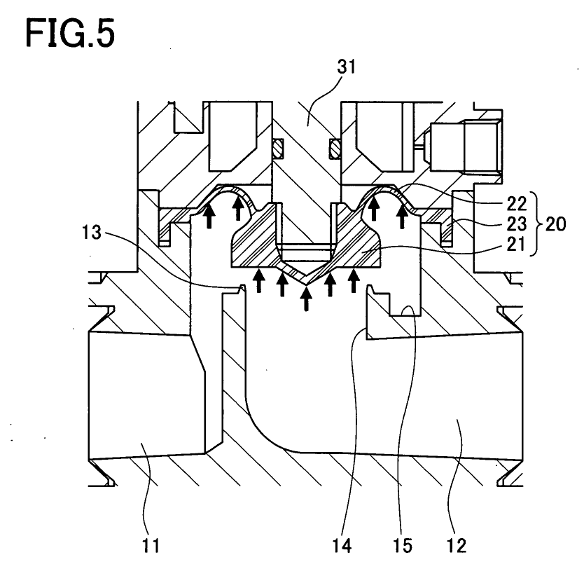

When the liquid is allowed to flow from the second flow passage 12 to the first flow passage 11 through the valve hole 14 and the groove 15, the main body 21 and the diaphragm part 22 receive the pressure from the liquid supplied to the second flow passage 12 as shown in FIG. 5.

When the diaphragm valve 1 is shifted from the valve-open state shown in FIG. 2 to the valve-closed state shown in FIG. 1, the distance between the diaphragm valve element 20 and the valve seat 13 becomes shorter as the piston rod 31 slides downward by the urging force of the spring 33. Therefore, the liquid supplied to the second flow passage 12 becomes hittable against the main body 21, whereas less hittable against the diaphragm part 22. Accordingly, the liquid pressure to the main body 21 is increased, whereas the liquid pressure to the diaphragm part 22 is decreased.

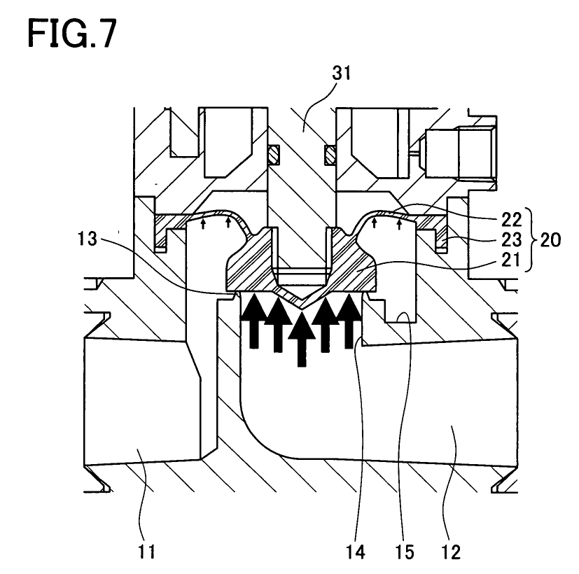

However, the pressure-applied area of the main body 21 is as large as, or larger than that of the diaphragm part 22. Therefore, the pressure applied to the entire diaphragm valve element 20 is not significantly decreased even though the liquid pressure to the diaphragm part 22 is decreased. The pressure changes in the pressure chamber exert a greater effect on the valve-closed operation than the liquid pressure changes do. Therefore, the air can be gradually discharged from the operation port, so that the piston rod 31 which is integrally secured to the diaphragm valve element 20 slides downward slowly against the urging force of the spring 33. Even when getting close to the valve-closed position, the piston rod 31 goes on sliding down slowly against the urging force of the spring 33 and brings the diaphragm valve element 20 into contact with the valve seat 13, providing the valve-closed state as shown in FIG. 7. Accordingly, the liquid in the first flow passage 11 does not receive the negative pressure, which can prevent the occurrence of the water hammer.

Furthermore, in the diaphragm valve 1 of this embodiment, the fixing face 37 extending in contact with part of the diaphragm part 22 supports the pressure-applied area of the diaphragm part 22 against the liquid pressure from below. Therefore, the pressure-applied area in the diaphragm valve element 20 is decreased by the area of the fixing face 37 extending to the diaphragm part 22. The urging force of the spring 33 to close the diaphragm valve element 20 can be reduced by this respect. Also, the piston rod 21 can slowly slide downward to the position for the valve-closed state more reliably.

Accordingly, the main body 21 of the diaphragm valve element 20 can be pressed against the valve seat 13 with a lower load. The main body 21 and the valve seat 13 both of which are made of the fluorine resin can be less deformable, which increase the useful life of the diaphragm valve 1. The occurrence of the water hammer can be prevented more reliably.

In the diaphragm valve element 20, the root 25 is provided uprightly, and the fixed part 23 is positioned higher than the root 25 in the valve-closed state. As a result of these respects, the diaphragm part 22 in an upward curve is never warped downward in valve-opening/closing operation. Further, the diaphragm part 22 shaped as above can be warped depending on the valve-opening/closing operation, supporting the stroke of the main body 21 sufficiently.

Furthermore, in the valve-open state, the fixing face 37 of the cylinder supports the boundary portion between the diaphragm part 22 and the fixed part 23 in which the cross-sectional areas largely change, along a direction to which the diaphragm part 22 is warped. This can avoid the concentration of the pressure on the boundary portion in which the cross-sectional areas largely change, and increase the useful life of the diaphragm valve 1. Further, the diaphragm part 22 is supported by and along the guide 38 slightly sloped, so that which can also reduce the concentration of the pressure to the boundary portion between the diaphragm part 22 and the fixed part 23, and increase the useful life of the diaphragm valve 1.

While the presently preferred embodiment of the present invention has been shown and described, the present invention may be embodied in other specific forms without departing from the spirit or essential characteristics thereof. For instance, the air cylinder is used as an actuator to open the diaphragm valve element 20 against the urging force of the spring 33 in this embodiment. A solenoid may also be used as the actuator.

1. A diaphragm valve comprising:
a body having an upper opening;
a first flow passage and a second flow passage formed in the body to open into the upper opening;
a diaphragm valve element covering the upper opening to form an airtight space through which the first and second flow passages are allowed to communicate with each other;
a valve seat formed in the body;
an urging member urging the diaphragm valve element against the valve seat into a valve-closed state; and
an actuator adapted to bring the diaphragm valve element out of contact with the valve seat into a valve-opened state;
wherein the diaphragm valve element comprising:
a main body which is to be brought into/out of contact with the valve seat;
a diaphragm part formed extending in a curve, radially from the main body and including a root connected to the main body and positioned inside the diameter of the valve seat, and
a fixed part formed at an outer peripheral edge of the diaphragm part and held at a position higher than the root during the valve-closed state.

2. The diaphragm valve according to claim 1,
wherein the diaphragm valve element in which the diaphragm part having a thin wall and the fixed part having a thick wall are formed so that respective upper surfaces are flush with each other, and the fixed part is held between an a lower fixing face and an upper fixing face which extends to the diaphragm part.

3. The diaphragm valve according to claim 2,
wherein a guide face having a slope contiguous from the upper fixing face above the diaphragm part so that the diaphragm part comes into contact with the guide face when the diaphragm valve element is separated from the valve seat.

4. The diaphragm valve according to claim 1,
a fluid-pressure-receiving area of the valve body part is as large as or larger than a fluid-pressure-applied area of the diaphragm part.

5. The diaphragm valve according to claim 2,
the fluid-pressure-receiving area of the valve body part is as large as or larger than a fluid-pressure-applied area of the diaphragm part.

6. The diaphragm valve according to claim 3,
the fluid-pressure-receiving area of the valve body part is as large as or larger than a fluid-pressure-applied area of the diaphragm part.
